(19) United States
(12) Patent Application Publication
(10) Pub. No.: US 2026/0029612 A1
(43) Pub. Date: Jan. 29, 2026

(54) BINOCULAR TUBE AND STEREOSCOPIC OPTICAL OBSERVATION APPARATUS

(71) Applicant: CARL ZEISS MEDITEC AG, Jena (DE)

(72) Inventors: Jonathan ESSIG, Aalen (DE); Christian BEDER, Aalen (DE); Armin VINCON, Aalen (DE)

(21) Appl. No.: 19/279,465

(22) Filed: Jul. 24, 2025

(30) Foreign Application Priority Data
Jul. 26, 2024 (DE) 10 2024 121 430.9

(51) Int. Cl. G02B 7/12; G02B 7/02; G02B 7/04; G02B 21/00; G02B 21/06; G02B 21/22; G02B 25/00

(52) U.S. Cl. CPC G02B 7/12; G02B 7/023; G02B 7/04; G02B 21/0012; G02B 21/06; G02B 21/22; G02B 25/001

(57) ABSTRACT

A binocular tube is equipped with an eyepiece viewer having a first eyepiece and a second eyepiece; a tilting mechanism for tilting the eyepiece viewer about a tilt axis; a pupillary distance adjusting device for adjusting the pupillary distance between the first eyepiece and the second eyepiece of the eyepiece viewer; and at least one manually operable actuation element coupled or couplable to the pupillary distance adjusting device and which makes it possible to set the pupillary distance by an actuation action. The binocular tube is equipped with a switching device enabling switching from a coupling of the manually operable actuation element to the pupillary distance adjusting device to a coupling of the manual actuation element to the tilting mechanism of the eyepiece viewer, such that the actuation action makes it possible to set the tilting of the eyepiece viewer instead of setting the pupillary distance.

The present invention relates to a binocular tube. In addition, the invention relates to a stereoscopic optical observation apparatus comprising a binocular tube.

Binocular tubes are used in particular in stereoscopic optical observation apparatuses such as surgical microscopes or other stereo microscopes. In order to make it possible for a stereoscopic representation of an observation object to be made available to a person viewing the observation object with the aid of a stereoscopic optical observation apparatus, such observation apparatuses have a left and a right imaging beam path. In order to be able to view the left imaging beam path with the left eye and the right imaging beam path with the right eye, use is made of the binocular tubes having an eyepiece viewer comprising a left eyepiece for the left imaging beam path and a right eyepiece for the right imaging beam path.

In order to make it possible to adapt to different pupillary distances of different users, binocular tubes generally provide for adapting the pupillary distance, i.e. the distance between left and right eyepieces. The adaptation of this interocular distance is often realized here by way of spindle drives that vary the distance between the eyepiece lens systems. Examples of stereoscopic optical observation apparatuses that make it possible to set the pupillary distance are disclosed in DE 10 2005 043 646 B4 and DE 10 2009 037 921 B4. The pupillary distance is usually set with the aid of a rotary knob present on the binocular tube.

In the case of a stereoscopic optical observation apparatus, it is advantageous from the standpoint of ergonomics for the user if positionability of the eyepiece viewers that is as free as possible can be effected. Especially in surgical microscopes, high freedom in the positionability of the eyepiece viewers is desirable in order to make possible an ergonomically optimum work position for a surgeon. By way of example, if the eyepiece viewer is intended to be repositioned or readjusted during an operation, precise and intuitive settability of the binocular tube is required here. In order to make possible an adaptation to the ergonomic preferences of the user, therefore, in the case of the binocular tube described in DE 10 2009 037 921 B4, an extensive setting of the binocular tube can be effected, which also encompasses the heights of the eyepiece viewer and the viewing angle into the eyepiece viewer. The desired position is set here by manipulating different parts of the binocular tube in order to tilt the parts about individual axes relative to one another.

In total, a plurality of operating elements are present for setting the pupillary distance and for setting the position of the eyepiece viewer. If high sterility requirements are an additional factor, as in the case of a surgical microscope, for instance, care must be taken to ensure the sterility of the operating elements. This is typically done by attaching sterile caps to the operating elements, which increases the preparation outlay for the use of a surgical microscope.

By comparison with DE 10 2009 037 921 B4, it is an object of the invention to provide a binocular tube and also a stereoscopic optical observation apparatus in which the number of operating elements present for setting the pupillary distance and for setting the position of the eyepiece viewer is reduced.

This object is achieved by a binocular tube as claimed in claim 1 and by a stereoscopic optical observation apparatus as claimed in claim 10. The dependent claims contain advantageous configurations of the invention.

A binocular tube according to the invention comprises an eyepiece viewer comprising a first eyepiece and a second eyepiece. In this case, the binocular tube can be purely optical, that is to say that a left and a right aerial image are viewed using purely optical means by way of the binocular tube. Alternatively, the binocular tube can be a digital tube that reproduces right and left digital images recorded by means of displays of cameras.

Moreover, the binocular tube comprises a tilting mechanism for tilting the eyepiece viewer. In this case, the tilting is typically effected about a tilt axis parallel to an imaginary connecting line between the first eyepiece and the second eyepiece of the eyepiece viewer. In this case, the connecting line can be e.g. the connecting line between the midpoints of the eye-side eyepiece lenses, the connecting line between the midpoints of the exit pupils of the eyepieces, the connecting lines between the entrance pupils of the eyepieces, etc.

Furthermore, the binocular tube comprises a pupillary distance adjusting device for adjusting the pupillary distance between the first eyepiece and the second eyepiece of the eyepiece viewer, and at least one manually operable actuation element which is coupled or couplable to the pupillary distance adjusting device and which makes it possible to set the pupillary distance by means of an actuation action. In other words, the manually operable actuation element is configured in such a way that an actuation of the actuation element leads to a setting of the pupillary distance. In particular, the manually operable actuation element can be configured to be movable in such a way that a movement of the actuation element leads to a setting of the pupillary distance. In this case, the movement of the actuation element is brought about by means of the actuation action. The manually operable actuation element can be a rotary knob, for example. The movement of the actuation element is then a rotary movement and the actuation action is rotation of the rotary knob. However, actuation elements which are displaceable along a displacement path are also possible. The actuation action is then displacement of the actuation element. One example of a displaceable actuation element is a sliding potentiometer. The coupling between the manually operable actuation element and the pupillary distance adjusting device can be of mechanical or electrical nature.

According to the invention, the binocular tube additionally comprises a switching device enabling switching from a coupling of the manually operable actuation element to the pupillary distance adjusting device to a coupling of the manual actuation element to the tilting mechanism of the eyepiece viewer, such that the actuation action makes it possible to set the tilting of the eyepiece viewer instead of setting the pupillary distance. If the actuation element is a rotary knob, for example, the rotation of the rotary knob thus makes it possible to set the tilting of the eyepiece viewer when the manual actuation element is coupled to the tilting mechanism of the eyepiece viewer.

The number of operating elements for setting the pupillary distance and setting the tilting of the eyepiece viewer is reduced. If the operating element is a rotary knob, the setting of the tilting of the eyepiece viewer can be effected intuitively by a rotary movement.

The coupling of the manual actuation element to the tilting mechanism of the eyepiece viewer can be effected mechanically via a gear mechanism arranged between the actuation element and the tilting mechanism.

Out of all the axes of rotation about which the binocular tube can typically be adjusted, the tilt axis for the tilting of the eyepiece viewer is the closest to the eyepiece viewer. On account of the resulting poor leverage, the force expenditure required for the tilting is the highest in comparison with the other adjustment possibilities. The gear mechanism enables a force conversion, such that an operator can accomplish the tilting with a reduced force expenditure during actuation of the operating element.

Instead of a mechanical coupling, it is also possible that the tilting mechanism of the eyepiece viewer comprises a drive motor for the motor-driven tilting of the eyepiece viewer and the coupling of the manual actuation element to the tilting mechanism of the eyepiece viewer is effected electronically in such a way that the drive motor is controllable by means of the actuation element. For this purpose, the tilting mechanism of the eyepiece viewer can comprise a drive motor controller for controlling the drive motor. The coupling of the manual actuation element to the tilting mechanism of the eyepiece viewer can then be effected via a position sensor connected to the drive motor controller, said position sensor detecting the position or a change in position of the actuation element and outputting a position signal representing the detected position or a change in position to the drive motor controller. The drive motor controller then controls the drive motor on the basis of the position signal in order to bring about a position of the tilting mechanism of the eyepiece viewer that corresponds to the position or the change in position. In the case of a rotary knob as operating element, the position sensor is a rotary position sensor that detects the rotary position of the rotary knob or a change in rotary position of the rotary knob and outputs a signal representing the rotary position or the change in rotary position as position signal to the drive motor controller. By virtue of the drive motor of the tilting mechanism and the electronic coupling of the operating element to the tilting mechanism, the force expenditure required by an operator for actuating the operating element can be completely decoupled from the force expenditure required for the tilting of the eyepiece viewer.

As an alternative or in addition to the drive motor of the tilting mechanism, the pupillary distance adjusting device can comprise a setting motor for the motor-driven setting of the pupillary distance. In this case, the coupling of the manual actuation element to the pupillary distance adjusting device is effected electronically in such a way that the setting motor is controllable by means of the actuation element. If both the tilting mechanism and the pupillary distance adjusting device are provided with a motor, the switching device manages without complex mechanical structures, such that it can be kept simple and low-maintenance.

If the pupillary distance adjusting device comprises a setting motor for the motor-driven setting of the pupillary distance, an operating terminal can additionally be present, via which the setting motor of the pupillary distance adjusting device and/or the drive motor of the tilting mechanism are/is controllable. In addition or as an alternative to the operating terminal, a voice input device can be present, via which the setting motor of the pupillary distance adjusting device and/or the drive motor of the tilting mechanism are/is controllable by means of voice commands. Preferences of different users can be taken into account by virtue of the operating terminal additionally present and/or by virtue of the voice input device additionally present. Moreover, a redundant system for setting the pupillary distance and/or the tilting of the eyepiece viewer is thus available.

In one advantageous configuration of the binocular tube, a display for displaying the set pupillary distance is present. Said display can be a scale that is present on the binocular tube and is mechanically coupled to the pupillary distance adjusting device, if the adjustment of the pupillary distance is effected purely mechanically. If a setting motor for the adjustment of the pupillary distance is present, a display that displays the pupillary distance currently set can be present on the binocular tube. If a setting motor and additionally an operating terminal are present, there is also the possibility of the pupillary distance also being displayed on the operating terminal in addition or as an alternative to being displayed on the display present on the binocular tube.

The switching between the coupling to the pupillary distance adjusting device and the coupling to the tilting mechanism can be brought about e.g. by a switching element integrated into the operating element. Said switching element can be for instance a pushbutton switch or sliding switch, the position of which brings about a coupling either to the pupillary distance adjusting device or to the tilting mechanism. In the case of a rotary knob, the switching element can be e.g. a switch that is actuated by pressing or pulling the rotary knob. In the case of a mechanical coupling, however, pressing or pulling the rotary knob can also directly cancel the coupling to the pupillary distance adjusting device and bring about the coupling to the tilting mechanism, or vice versa. However, electronic switching is also possible, e.g. by means of a switching button which is arranged on the binocular viewer or on the binocular tube and the actuation of which instigates the switching. However, the switching button can also be integrated into the operating element, in which case the location on the operating element at which the switching button is integrated into the operating element should be chosen such that inadvertent actuation of the switching button can be reliably avoided.

The invention additionally provides a stereoscopic optical observation apparatus comprising optical elements for generating a stereoscopic intermediate image, i.e. an intermediate image comprising a left and a right stereoscopic partial image, and a binocular tube according to the invention for viewing the stereoscopic intermediate image, i.e. for viewing the left stereoscopic partial image by means of one eyepiece and the right stereoscopic partial image by means of the other eyepiece. In this case, the binocular tube can be purely optical, i.e. the left and right stereoscopic partial images are aerial images viewed directly by means of the binocular tube. Alternatively, the binocular tube can be a digital tube which, by means of two displays, reproduces a left stereoscopic partial image of the stereoscopic intermediate image recorded by a camera and a right stereoscopic partial image of the stereoscopic intermediate image recorded by a camera. The stereoscopic optical observation apparatus can be for example a stereo microscope and in particular a surgical microscope.

The advantages attainable with the stereoscopic optical observation apparatus according to the invention become apparent directly from the use of the binocular tube according to the invention. With regard to the advantages, therefore, reference is made to the advantages described with regard to the binocular tube according to the invention.

Further features, properties and advantages of the present invention will become apparent from the following exemplary embodiments with reference to the accompanying figures.

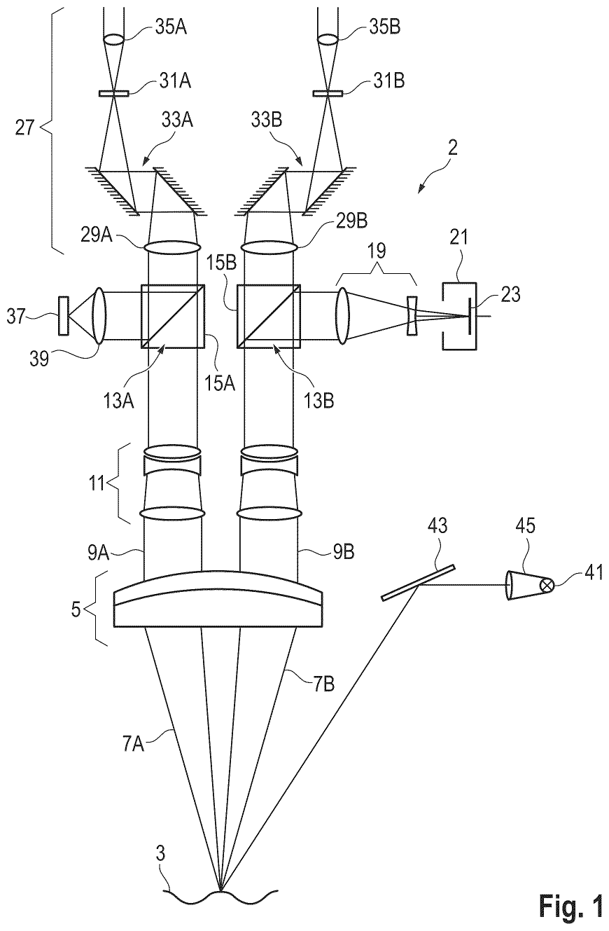

FIG. 1 shows one example of the setup of a surgical microscope.

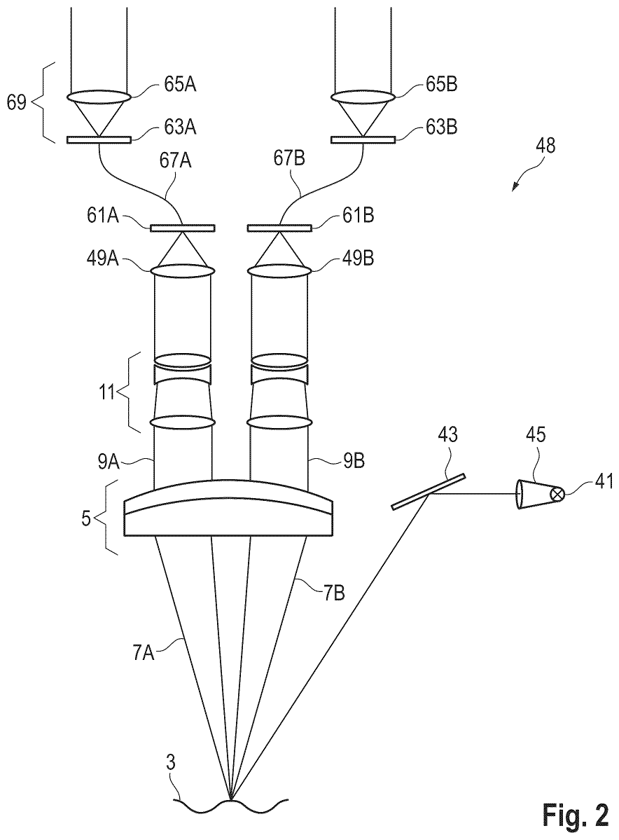

FIG. 2 shows one example of the setup of a digital surgical microscope.

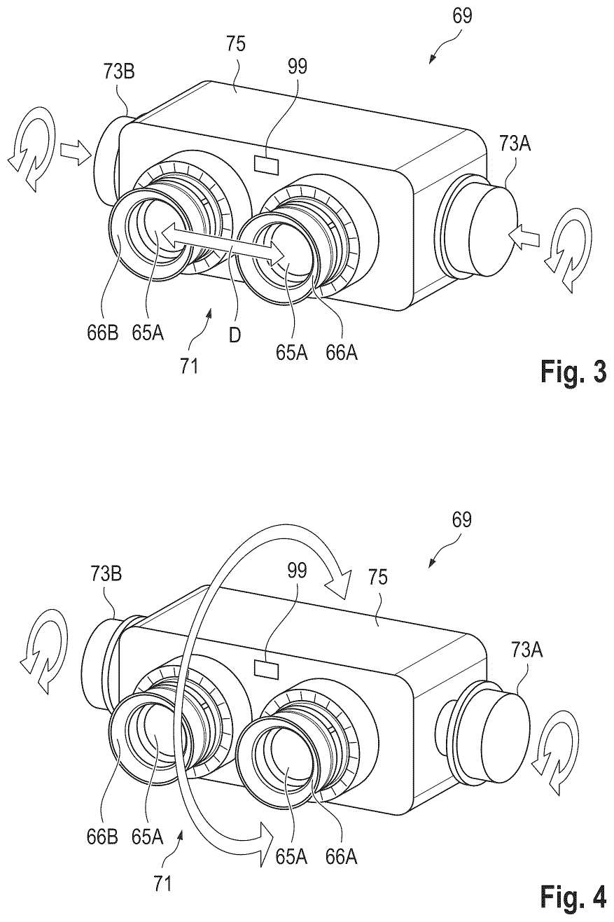

FIG. 3 shows a digital binocular tube and the adjustment of the pupillary distance of the eyepiece viewer.

FIG. 4 shows the tilting of the eyepiece viewer of the digital binocular tube from FIG. 3.

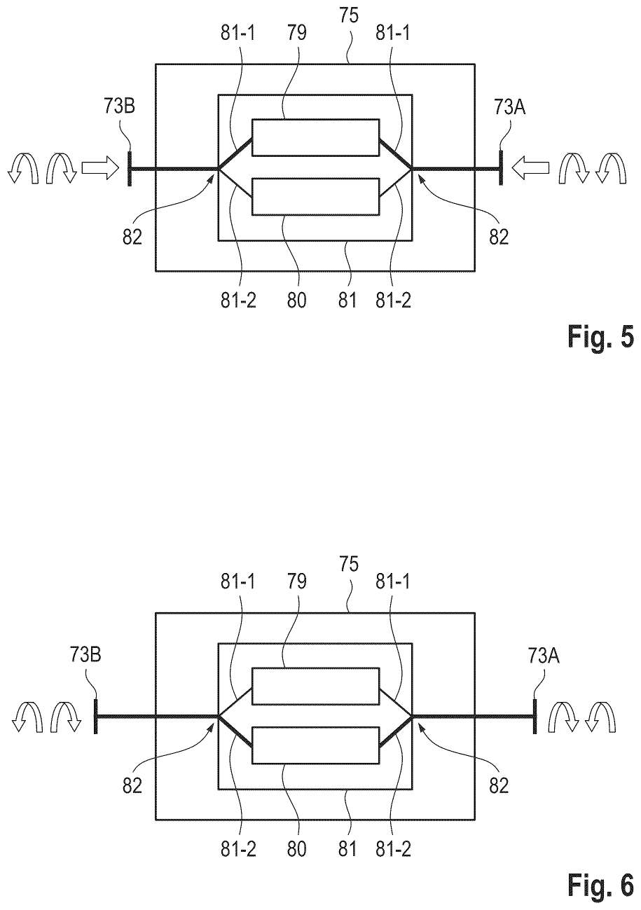

FIG. 5 schematically shows the coupling of a rotary knob to a pupillary distance adjusting device of the digital eyepiece viewer.

FIG. 6 schematically shows the coupling of a rotary knob to a tilting mechanism for tilting the digital eyepiece viewer.

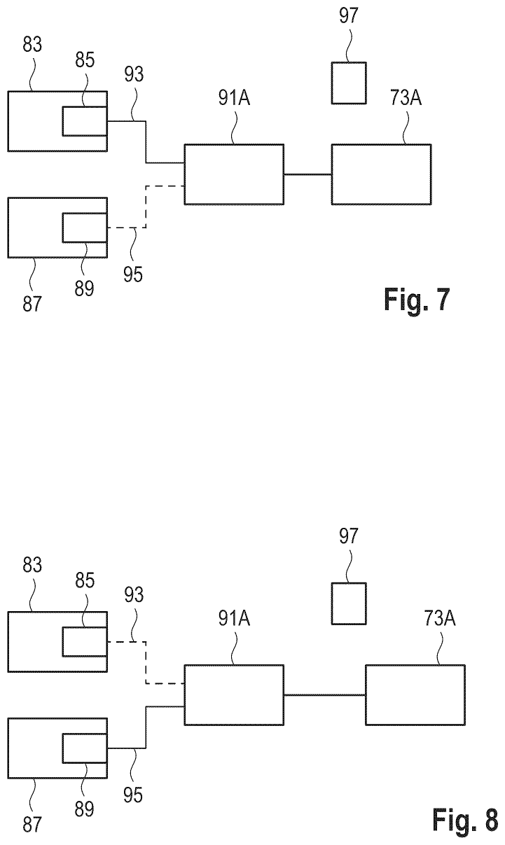

FIG. 7 schematically shows a coupling of a rotary knob to a motor of a pupillary distance adjusting device of the digital eyepiece viewer.

FIG. 8 schematically shows the coupling of a rotary knob to a motor of a tilting mechanism for tilting the digital eyepiece viewer.

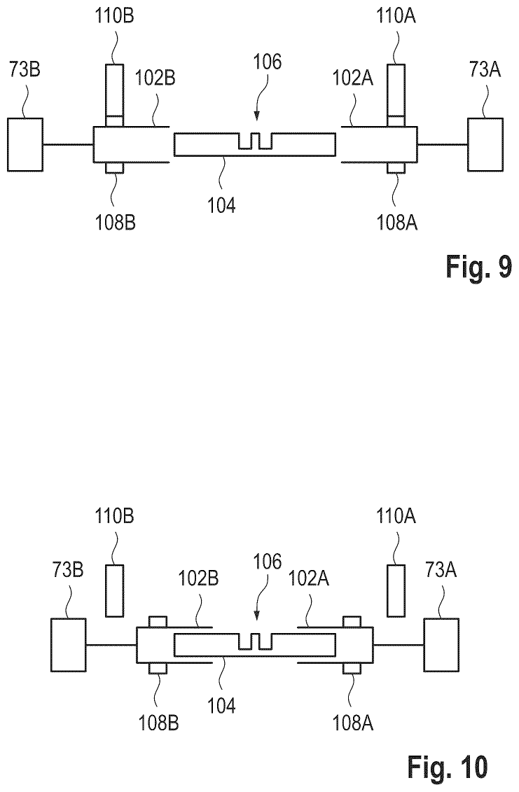

FIG. 9 schematically shows a variant in which the pupillary distance adjustment and the tilting are effected in a manually driven manner, in a first state.

FIG. 10 schematically shows a variant in which the pupillary distance adjustment and the tilting are effected in a manually driven manner, in a second state.

The basic setup of a stereoscopic optical observation apparatus is explained below on the basis of the example of a surgical microscope with reference to FIGS. 1 and 2.

As essential component parts, the surgical microscope 2 shown in FIG. 1 comprises an objective 5 that should face an object field 3 and can be embodied as an achromatic or apochromatic objective, in particular. In the present exemplary embodiment, the objective 5 consists of two partial lenses that are cemented to one another and form an achromatic objective. The object field 3 is arranged in the focal plane of the objective 5 such that it is imaged at infinity by the objective 5. Expressed differently, a divergent beam 7 emanating from the object field 3 is converted into a parallel beam 9 during its passage through the objective 5.

A magnification changer 11 is arranged on the observer side of the objective 5 and can be embodied either as a zoom system for changing the magnification factor in a continuously variable manner, as in the illustrated exemplary embodiment, or as what is known as a Galilean changer for changing the magnification factor in a stepwise manner. In a zoom system constructed e.g. from a lens combination comprising three lenses (these being two positive lenses and one negative lens in the illustration shown in FIG. 1), the two object-side lenses can be displaced in order to vary the magnification factor. In actual fact, however, the zoom system can also have more than three lenses, for example four or more lenses, in which case the outer lenses then can also be arranged in a fixed manner. In a Galilean changer, by contrast, there are a plurality of fixed lens combinations which represent different magnification factors and which can be introduced into the beam path in alternation. Both a zoom system and a Galilean changer convert an object-side parallel beam into an observer-side parallel beam with a different beam diameter. In the present exemplary embodiment, the magnification changer 11 is already part of the binocular beam path of the surgical microscope 1, i.e. it has a dedicated lens combination for each stereoscopic partial beam path 9A, 9B of the surgical microscope 1. In the present exemplary embodiment, a magnification factor is set by means of the magnification changer 11 by way of a motor-driven actuator which, together with the magnification changer 11, is part of a magnification changing unit for setting the magnification factor.

The magnification changer 11 is adjoined on the observer side by an interface arrangement 13A, 13B, by means of which external apparatuses can be connected to the surgical microscope 2 and which comprises beam splitter prisms 15A, 15B in the present exemplary embodiment. However, in principle, use can also be made of other types of beam splitters, for example partially transmissive mirrors. In the present embodiment, the interfaces 13A, 13B serve to output couple a beam from the beam path of the surgical microscope 2 (beam splitter prism 15B) and to input couple a beam into the beam path of the surgical microscope 2 (beam splitter prism 15A).

In the present exemplary embodiment, the beam splitter prism 15A in the partial beam path 9A serves to mirror information or data for an observer into the partial beam path 9A of the surgical microscope 2 with the aid of a display 37, for example a digital mirror device (DMD) or an LCD display, and an associated optical unit 39 by means of the beam splitter prism 15A. A camera adapter 19 with a camera 21 secured thereto, said camera being equipped with an electronic image sensor 23, for example with a CCD sensor or a CMOS sensor, is arranged at the interface 13B in the other partial beam path 9B. It is possible by means of the camera 21 to record an electronic image and, in particular, a digital image of the object field 3. In particular, a hyperspectral sensor can also be used as an image sensor, said hyperspectral sensor having not just three spectral channels (e.g. red, green and blue) but rather a multiplicity of spectral channels.

On the observer side, the interface 13 is adjoined by a binocular tube 27, which is embodied as a purely optical tube in the present example. In the present example, said tube has two tube objectives 29A, 29B, which focus the respective parallel beam 9A, 9B on an intermediate image plane 31, i.e. image the object field 3 as an aerial image into the respective intermediate image plane 31A, 31B. Finally, the aerial images situated in the intermediate image planes 31A, 31B are in turn imaged at infinity by eyepiece lenses 35A, 35B, and so an observer can view the aerial images with relaxed eyes. Moreover, the distance between the two partial beams 9A, 9B is increased in the binocular tube by means of a mirror system or by means of prisms 33A, 33B in order to adapt said distance to the interocular distance of the observer. In addition, image erection is carried out by the mirror system or the prisms 33A, 33B.

The surgical microscope 2 is additionally equipped with an illumination device, with which the object field 3 can be illuminated with broadband illumination light in the present example. For this purpose, the illumination device has a white-light source 41, for example a halogen lamp or a gas discharge lamp, in the present example. The light emanating from the white-light source 41 is directed via a deflection mirror 43 or a deflection prism in the direction of the object field 3 in order to illuminate the latter. Furthermore, an illumination optical unit 45 is present in the illumination device and ensures uniform illumination of the entire observed object field 3.

Reference is made to the fact that the illumination beam path illustrated in FIG. 1 is highly schematic and does not necessarily reproduce the actual course of the illumination beam path. In principle, the illumination beam path can be designed as what is known as oblique illumination, which comes closest to the schematic illustration in FIG. 1. In such oblique illumination, the beam path extends at a relatively large angle (approximately 6° or more) with respect to the optical axis of the objective 5 and, as illustrated in FIG. 1, can extend completely outside the objective. Alternatively, however, there is also the possibility of allowing the illumination beam path of the oblique illumination to extend through a marginal region of the objective 5. A further possibility for the arrangement of the illumination beam path is what is known as 0° illumination, in which the illumination beam path extends through the objective 5 and is input coupled into the objective 5 between the two partial beam paths 9A, 9B, along the optical axis of the objective 5 in the direction of the object field 3. Finally, there is also the possibility of embodying the illumination beam path as what is known as coaxial illumination, in which a first illumination partial beam path and a second illumination partial beam path are present. The illumination partial beam paths are input coupled into the surgical microscope in a manner parallel to the optical axes of the observation partial beam paths 9A, 9B by way of one or more beam splitters such that the illumination extends coaxially in relation to the two observation partial beam paths.

FIG. 2 shows one example of a digital surgical microscope 48 in a schematic illustration. In this surgical microscope, the main objective 5, the magnification changer 11, which merely represents an option in the digital surgical microscope and hence need not necessarily be present, and the illumination system 41, 43, 45 do not differ from the surgical microscope 2 with an optical viewing unit, illustrated in FIG. 1. The difference lies in the fact that the surgical microscope 48 shown in FIG. 2 does not comprise an optical binocular tube. Instead of the tube objectives 29A, 29B from FIG. 1, the surgical microscope 48 from FIG. 2 comprises focusing lenses 49A, 49B, by means of which the binocular observation beam paths 9A, 9B are imaged on digital image sensors 61A, 61B. In this case, the digital image sensors 61A, 61B can be CCD sensors or CMOS sensors, for example. The images recorded by the image sensors 61A, 61B are transmitted digitally to digital displays 63A, 63B, which can be embodied as LED displays, as LCD displays or as displays based on organic light-emitting diodes (OLEDs). As in the present example, eyepiece lenses 65A, 65B can be assigned to the displays 63A, 63B, by means of which lenses the images presented on the displays 63A, 63B are imaged at infinity such that an observer can view said images with relaxed eyes. In the present example, the displays 63A, 63B and the eyepiece lenses 65A, 65B are part of a digital binocular tube 69.

In the case of the binocular tube shown in FIGS. 1 and 2, the pupillary distance of the eyepiece viewer can be set in order to be able to adapt it to the interocular distance of a user. Moreover, the eyepiece viewer can be tilted in order to be able to adapt its inclination to the user's ergonomic preferences. One example of the setting of the pupillary distance D of the eyepiece viewer 71 of a digital binocular tube 69 is shown in FIG. 3. FIG. 4 shows the tilting of the eyepiece viewer 71 of the binocular tube 69.

The binocular tube 69 shown in FIGS. 3 and 4 comprises a housing 75, in which the displays 63A, 63B showing stereoscopic partial images of the object field 3 are arranged. Furthermore, eyepieces 66A, 66B are arranged in the housing 75 and can be used to view the stereoscopic partial images shown on the displays 63A, 63B. The pupillary distance D of the eyepieces 66A, 66B can be set by means of operating elements, configured as rotary knobs 73A, 73B in the example shown. The pupillary distance D increases upon rotation of the rotary knobs 73A, 73B in one direction, and decreases upon rotation in the opposite direction. However, the rotary knobs 73A, 73B also allow tilting of the binocular tube 69 and thus of the eyepiece viewer 71, as is shown in FIG. 4. In order to make it possible to tilt the eyepiece viewer 71 using the same rotary movements on the rotary knobs 73A, 73B as when setting the pupillary distance, a switching device is present, with the aid of which the rotary knobs 73A, 73B can be assigned either to a pupillary distance adjusting device for setting the pupillary distance D or to a tilting mechanism for tilting the eyepiece viewer 71.

FIGS. 5 and 6 highly schematically show the pupillary distance adjusting device 79 and the tilting mechanism 80 of the binocular tube 69. A gear mechanism 81 is present besides the pupillary distance adjusting device 79 and the tilting mechanism 80, and comprises a first gear mechanism part 81-1 for driving the pupillary distance adjusting device 79 and a second gear mechanism part 81-2 for driving the tilting mechanism 80 by means of the rotary movement of the rotary knobs 73A, 73B. By means of a switching device 82, configured as a coupling in the present exemplary embodiment, the rotary knobs 73A, 73B can be coupled either to the first gear mechanism part 81-1 assigned to the pupillary distance adjusting device 79 or to the second gear mechanism part 81-2 assigned to the tilting mechanism 80. In the present example, the gear mechanism part to which the rotary knobs 73A, 73B are coupled depends on whether the rotary knobs 73A, 73B are engaged, as is illustrated schematically in FIG. 5, or disengaged, as is illustrated schematically in FIG. 6.

If the rotary knobs 73A, 73B are in the engaged state, as shown in FIG. 5, they are connected to a shaft of the first gear mechanism part 81-1, i.e. the gear mechanism part for the pupillary distance adjusting device 79. Said shaft can have helical guide grooves, for example, into which pins of the eyepieces 66A, 66B engage. The eyepieces 66A, 66B are guided linearly, the linear position of the eyepieces 66A, 66B being defined by the position of the pins. The position of the pins is displaced linearly upon rotation of the shaft of the first gear mechanism part 81-1 by means of the helical guide grooves, as a result of which the pupillary distance can be established. A corresponding gear mechanism is disclosed in DE 10 2009 037 921 B4, for example, to which reference is made for details of the gear mechanism.

By contrast, if the rotary knobs 73A, 73B are in the disengaged state shown in FIG. 6, they are connected to a shaft of the second gear mechanism part 81-2, which is assigned to the tilting mechanism 80. In this case, the tilting of the binocular tube 69 and thus of the eyepiece viewer 71 can be set by rotation of the rotary knobs 73A, 73B. In this case, the transmission ratio of the second gear mechanism part 81-2 can differ from the transmission ratio of the first gear mechanism part 81-1. What can be achieved as a result is that a user can carry out both the setting of the pupillary distance and the tilting of the eyepiece viewer 71 with an appropriate force expenditure, even if for example the tilting necessitates a higher torque than that for the setting of the pupillary distance.

In the embodiment variant described with reference to FIGS. 5 and 6, both the setting of the pupillary distance and the tilting of the eyepiece viewer 71 are brought about by rotation of the rotary knobs 73A, 73B with the aid of mechanical means. However, it is also possible for the setting of the pupillary distance and/or the tilting of the eyepiece viewer 71 to be brought about in a motor-driven manner. In this case, the rotary knobs 73A, 73B serve for setting a control signal for the respective motor.

An embodiment variant in which both the setting of the pupillary distance and the tilting are effected in a motor-driven manner is illustrated schematically in FIGS. 7 and 8. Each of these figures illustrates only the rotary knob 73A and the connection thereof to controllers of the motors used. The other rotary knob 73B and its connection to the controllers of the motors are configured identically, however. It should be pointed out at this juncture that the binocular tube 69 need not necessarily have two rotary knobs 73A, 73B, rather that one rotary knob by itself is also sufficient, in principle. The presence of two rotary knobs 73A, 73B affords advantages, however. In this regard, in the case where setting of the pupillary distance is brought about purely mechanically or tilting is brought about purely mechanically, the necessary force expenditure can be distributed between both hands of a user. Moreover, a binocular tube 69 comprising a left and a right rotary knob 73A, 73B is particularly user-friendly insofar as it is handleable equally well for left-handers and right-handers.

The embodiment variant of the invention illustrated in FIGS. 7 and 8 has a setting motor 83 with a setting motor controller 85, which motor serves for the motor-driven setting of the pupillary distance and hence as a pupillary distance adjusting device. Furthermore, it has a drive motor 87 with a drive motor controller 89, which motor serves for the motor-driven setting of the tilting of the eyepiece viewer 71 and hence as a tilting mechanism. In this embodiment variant, the rotary knob 73A is assigned an angle encoder 91A, which functions as a position sensor that detects the rotary position of the rotary knob 73A. The detected rotary position of the rotary knob 73A is either output to the setting motor controller 85 by the angle encoder 91A via a first signal line 93 if the rotary knob 73A is engaged as illustrated in FIG. 7. By contrast, if the rotary knob 73A is disengaged, as illustrated in FIG. 8, the rotary position of the rotary knob 73A detected by the angle encoder 91A is by contrast output to the drive motor controller 89 via a second signal line 95. On the basis of the received rotary position, the respective controller then determines an actuating signal for the corresponding motor in order to set the pupillary distance represented by the rotary position of the rotary knob 73A or the tilting represented by the rotary position of the rotary knob 73A.

In order to detect whether the rotary knob 73A is engaged or disengaged, use is made of a detector 97 in the present example, said detector detecting whether the rotary knob 73A is in the engaged or disengaged position. Said detector 97 can be embodied as a proximity sensor, for example, which detects the proximity of the rotary knob 73A in its engaged state. This detection can be effected using magnetic means or optical means, for example. In one particularly simple configuration, the detector 97 can be embodied as a light barrier, the signal of which is interrupted when the rotary knob 73A is in the engaged state. In the embodiment variant of the invention shown in FIGS. 7 and 8, together with the engageable configuration of the rotary knob 73A, the detector 97 serves as a switching device enabling switching from a signaling coupling of the rotary knob 73A to the setting motor controller 85 of the setting motor 83 for the pupillary distance to a signaling coupling of the rotary knob 73A to the drive controller 89 of the drive motor 87 for the tilting.

In order to display the set pupillary distance, the binocular tube 69 has a display 99, which displays the set pupillary distance in centimeters. In the embodiment variants shown, this display 99 is situated between the two eyepieces 66A, 66B in the housing 75 of the binocular tube 69. However, it can also be arranged elsewhere, for example on the top side of the housing 75.

An embodiment variant in which both the setting of the pupillary distance and the tilting of the eyepiece viewer are effected purely mechanically in a manually driven manner is illustrated in FIGS. 9 and 10. Each of the figures shows the rotary knobs 73A, 73B connected to claw couplings 102A, 102B, which can couple to a central shaft 104. The claw couplings 102A, 102B are shown in the state decoupled from the central shaft 104 in FIG. 9, and in the state coupled to the central shaft 104 in FIG. 10. In this exemplary embodiment, too, the central shaft 104 has the helical guide grooves 106 already mentioned above, into which pins used to linearly guide the eyepieces can engage. Gearwheels 108A, 108B are arranged on the claw couplings 102A, 102B, and mesh with gearwheels 110A, 110B of the gear mechanism of the tilting mechanism in the state shown in FIG. 9.

If the rotary knobs 73A, 73B are in the disengaged state as shown in FIG. 9, the claw couplings 102A, 102B are decoupled from the central shaft 104. In this state, the gearwheels 108A, 108B engage into the gearwheels 110A, 110B of the gear mechanism of the tilting mechanism, such that they can mesh with them. Rotation of the rotary knobs 73A, 73B then drives the gear mechanism of the tilting mechanism by means of the gearwheels 108A, 108B, and so the tilting of the eyepiece viewer can be set by way of the gear mechanism. Since the claw couplings 102A, 102B are decoupled from the central shaft 104 in the disengaged state of the rotary knobs 73A, 73B, said central shaft does not concomitantly rotate upon rotation of the rotary knobs 73A, 73B, and so the pupillary distance does not change upon rotation of the rotary knobs 73A, 73B.

By contrast, if the knobs are engaged in the direction of the central shaft 104, as is illustrated in FIG. 10, the claw couplings 102A, 102B couple to the central shaft 104, and so rotation of the rotary knobs 73A, 73B leads to rotation of the central shaft 104. In this state, the gearwheels 108A, 108B are not in engagement with the gearwheels 110A, 110B of the gear mechanism of the tilting mechanism, and so rotation of the rotary knobs 73A, 73B, by way of the coupling to the central shaft 104, leads only to a change in the pupillary distance, but not to tilting of the eyepiece viewer.

The present invention has been described in detail on the basis of exemplary embodiments for explanatory purposes. However, a person skilled in the art will understand that they may depart from the described exemplary embodiments within the scope of the invention. In this regard, for example, there is the possibility of the pupillary distance being displayed on an operating terminal, if one is present, in addition to or instead of the presentation on the display 99 on the binocular tube 69. In the case of motor-driven setting of the pupillary distance, said operating terminal can afford the possibility of also setting the pupillary distance and/or the tilting of the binocular tube 69 by way of the operating terminal. A further possibility of setting the pupillary distance and/or the tilting, if said pupillary distance and/or tilting are/is settable in a motor-driven manner, is use of a voice input module, into which the pupillary distance to be set and/or e.g. the angle to be set for the tilting can be input by voice command. Moreover, there is the possibility of providing a combination of the motor-driven exemplary embodiment variant illustrated in FIGS. 7 and 8 and the manually driven exemplary embodiment variant illustrated in FIGS. 9 and 10. In this combination, for example, the central shaft illustrated in FIGS. 9 and 10 can be coupled to the rotary knobs via claw couplings, such that the pupillary distance is adjusted in a manually driven manner. In this variant, however, angle encoders would be present instead of the gearwheels arranged on the claw couplings, said angle encoders detecting the rotary position of the rotary knobs and outputting it to a drive motor controller for the setting of the tilting mechanism. Alternatively, however, there is also the possibility of combining the exemplary embodiment variants such that the pupillary distance is adjusted by motor and the tilting is set manually. Therefore, the present invention is not intended to be limited by the exemplary embodiments but rather only by the appended claims.

### LIST OF REFERENCE SIGNS

2 Surgical microscope
3 Object field
5 Objective
7A,B Divergent beam
9A,B Stereoscopic partial beam path
11 Magnification changer
13A,B Interface arrangement
15A,B Beam splitter prism
19 Camera adapter
21 Camera
23 Image sensor
27 Binocular tube
29A,B Tube objective
31A,B Intermediate image plane
33A,B Prism
35A,B Eyepiece lens
37 Display
39 Optical unit
41 White-light source
43 Deflection mirror
45 Illumination optical unit
48 Surgical microscope
49A,B Focusing lens
61A,B Image sensor
63A,B Display
65A,B Eyepiece lens
66A,B Eyepiece
67A,B Cable
69 Binocular tube
71 Eyepiece viewer
73A,B Rotary knob
75 Housing
79 Pupillary distance adjusting device
80 Tilting mechanism
81 Gear mechanism
81-1 First gear mechanism part
81-2 Second gear mechanism part
82 Switching device
83 Setting motor
85 Setting motor controller
87 Drive motor
89 Drive motor controller
91A Angle encoder
93 Signal line
95 Signal line
97 Detector
99 Display
102A,B Claw coupling
104 Shaft
106 Guide grooves
108A,B Gearwheel
110A,B Gearwheel
D Pupillary distance

1. A binocular tube comprising:
an eyepiece viewer having a first eyepiece and a second eyepiece;
a tilting mechanism for tilting the eyepiece viewer about a tilt axis;
a pupillary distance adjusting device for adjusting the pupillary distance between the first eyepiece and the second eyepiece of the eyepiece viewer;
at least one manually operable actuation element which is coupled or couplable to the pupillary distance adjusting device and which makes it possible to set the pupillary distance by an actuation action; and
a switching device enabling switching from a coupling of the manually operable actuation element to the pupillary distance adjusting device to a coupling of the manual actuation element to the tilting mechanism of the eyepiece viewer, such that the actuation action makes it possible to set the tilting of the eyepiece viewer instead of setting the pupillary distance.

2. The binocular tube as claimed in claim 1, wherein the manually operable actuation element is a rotary knob and the actuation action is rotation of the rotary knob.

3. The binocular tube as claimed in claim 1, wherein the coupling of the manual actuation element to the tilting mechanism of the eyepiece viewer is effected mechanically via a gear mechanism arranged between the actuation element and the tilting mechanism.

4. The binocular tube as claimed in claim 1, wherein the tilting mechanism of the eyepiece viewer comprises a drive motor for the motor-driven tilting of the eyepiece viewer and the coupling of the manual actuation element to the tilting mechanism of the eyepiece viewer is effected electronically in such a way that the drive motor is controllable by the actuation element.

5. The binocular tube as claimed in claim 4, wherein the tilting mechanism of the eyepiece viewer comprises a drive motor controller for controlling the drive motor and the coupling of the manual actuation element to the tilting mechanism of the eyepiece viewer is effected via a position sensor connected to the drive motor controller, said position sensor detecting the position or a change in position of the actuation element and outputting a position signal representing the detected position or a change in position to the drive motor controller, which controls the drive motor on the basis of the detected position signal in order to bring about a position of the tilting mechanism of the eyepiece viewer that corresponds to the position or the change in position.

6. The binocular tube as claimed in claim 1, wherein the pupillary distance adjusting device comprises a setting motor for the motor-driven setting of the pupillary distance and the coupling of the manual actuation element to the pupillary distance adjusting device is effected electronically in such a way that the setting motor is controllable by the actuation element.

7. The binocular tube as claimed in claim 6, wherein an operating terminal is additionally present, via which the setting motor of the pupillary distance adjusting device and/or the drive motor of the tilting mechanism are/is controllable.

8. The binocular tube as claimed in claim 6, wherein a voice input device is additionally present, via which the setting motor of the pupillary distance adjusting device and/or the drive motor of the tilting mechanism are/is controllable by voice commands.

9. The binocular tube as claimed in claim 1, wherein a display for displaying the set pupillary distance is present.

10. A stereoscopic optical observation apparatus comprising optical elements for generating a stereoscopic intermediate image and a binocular tube as claimed in claim 1 for viewing the stereoscopic intermediate image.
